(19) United States
(12) Patent Application Publication
(10) Pub. No.: US 2015/0264226 A1
(43) Pub. Date: Sep. 17, 2015

(54) METHODS AND DEVICES FOR PROVIDING ELECTRICAL ENERGY AND DATA THROUGH A PROTECTIVE CASE

(71) Applicant: Eran Gafni, Gadot (IL)

(72) Inventor: Eran Gafni, Gadot (IL)

(21) Appl. No.: 14/210,491

(22) Filed: Mar. 14, 2014

(51) Int. Cl. H04N 5/225

(52) U.S. Cl. CPC H04N 5/2252

(57) ABSTRACT

The invention discloses devices and methods for providing electrical energy and/or data from inside a protective case to an electrical device on the outside of the protective case. The instant invention, in some embodiments, places a battery pack or data transfer element in the back of a waterproof camera case and directs energy and/or data outside of the case to a peripheral such as a flashlight or WiFi router. The instant invention keeps the slender profile of GoPro and similar devices while allowing for added functionality to improve the use and performance of such electronic gear.

### FIELD AND BACKGROUND OF THE INVENTION

The present invention, in some embodiments thereof, relates to methods and devices for allowing the transfer of electrical energy and/or desired data from an inside of a closed protective case to an outside of said case. The instant invention, in some embodiments, allows for the provision of electrical energy from within a waterproof camera case to a lighting element on the outside of the same case.

One of the greatest revolutions in the electronics sphere has been the digital camera. Fifty years ago, there were only film cameras; today, Kodak is gone and only “experts” or photography buffs still use film cameras. Digital cameras have not only revolutionized traditional photography but have become integral parts of hundreds of millions of smartphones and tablet computers. A person leaves his/her house with a camera at the ready; such a situation never existed in the past. Entire websites are dedicated to the still and video images people upload hundreds of millions times each day.

Within the realm of digital cameras and more specifically digital video cameras, no company has shown as much recent success as GoPro (www.gopro.com). GoPro “action cameras” generally come with waterproof “skeletons” that allow for full camera control and button access. GoPro cameras, and their like, are easily attached to an arm or helmet or other surface (skis, surfboard, dog) and can film for hours as users ride, ski, play, and fly through the air. Extraordinary video taken within waves by surfers are now typically recorded by GoPro users. Soldiers are also being sent out with GoPro cameras attached to helmets or equipment.

One of the challenges facing GoPro and similar camera users is the lack of dedicated lighting. The GoPro video camera, designed for extended HD filming, does not include a dedicated light source. As lighting requires a fair amount of electrical energy, a dedicated source of power must be included in any external lighting arrangement. The challenge with such systems is that they can ruin the compact, easily portable nature of the GoPro family of cameras. To date, adding a light source to a GoPro camera requires significantly changing the overall camera/lighting system footprint and thus making the system less portable and usable in low light situations.

Additionally, while the newer GoPro devices are WiFi enabled, there are limits to data transfer from the waterproof, closed skeletons provided by the manufacturer. Improved data transfer as well as added functionalities such as connection of GoPro devices to additional electronic devices could improve its versatility and overall usefulness of such devices.

U.S. patent application Ser. No. 13/480,306 (presently allowed) to Clark & deSousa teaches camera cases configured to be positioned around a camera such that the camera is retained within the case while remaining operable. The case can have a generally cuboid shape with front, rear, top, bottom, left and right sides. At least two of these sides can comprise at least one mounting feature, such as a threaded hole. The rear side can comprise a door configured to allow a camera to be inserted into the case. The rear door can comprise an adjustable portion that can be coupled to the rear door in at least two different positions, such that the case is adjustable to be used with cameras of different sizes. A trigger button on a side of the case can be configured to activate a camera button positioned on a top side of a camera within the case. The case can be dirt and moisture resistant.

Chinese Patent CN202733617 describes a notebook computer camera auxiliary lighting apparatus, belonging to the computer auxiliary equipment manufacture field. The apparatus is LED illuminating lamps which can be lifted up or pressed down and are adjustable in angle. The LED illuminating lamps are mounted at the two sides of a touchpad of a notebook computer. The light intensity is controlled by the computer. When a computer Web camera is utilized by a user, the clear video transmission can be realized by adjusting the angle and light intensity of the illuminating lamps.

U.S. patent application Ser. No. 13/373,855 to Page & Coffman teaches a charge-coupled device camera architecture for improving the dynamic range of the charge-coupled device camera having a charge-coupled device camera contained within a vacuum capable camera case and electrically attached to the outside of the camera case; a thermoelectric cooler thermally attached to a back side of the charge-coupled device camera and electrically attached to the outside of the camera case; a thermal redistribution block thermally attached to the thermoelectric cooler and further thermally attached to the camera case; a pressure measuring mechanism attached to an inside surface of the camera case and electrically connected to the outside of the camera case; a temperature measuring mechanism attached to a surface of the thermal redistribution block and electrically connected to the outside of the camera case; and a vacuum evacuation assembly having an indium lined copper pinch tube.

U.S. patent application Ser. No. 13/417,571 to Karn, et al. describes a digital camera system providing a low-power image capture mode including an image capture system, an image display and a power management system. The power management system is used to provide a normal image capture mode wherein captured digital images are displayed on the image display as they are captured, and a low-power image capture mode wherein captured digital images are not displayed on the image display as they are captured. A user interface includes a first user control for selecting between the normal image capture mode and the low-power image capture mode, and a second user control for initiating a video capture operation. The system is configured such that if the first user control is activated while a digital video is being captured, the power management system switches between the normal image capture mode and the low-power image capture mode without interrupting the video capture operation.

### SUMMARY OF THE INVENTION

It is therefore a purpose of the present invention, in some embodiments, to describe methods and devices for providing electrical energy and optionally data transfer from an inside of a camera case to an electrical device attached to an outside of the same camera case. In some embodiments of the invention, a battery back is placed within a waterproof camera case, and the energy from the battery back is directed towards add-ons or peripherals attached to or located outside of the case.

The invention includes a device for providing electrical energy or data from inside a protective case to an electrical device located outside of the protective case, including: a first portion of a case, the first portion adapted to reversibly attach to a second portion of the case to form a complete case for physical protection of an electronic device located inside and separate from the case; at least one energy-data transfer unit adapted to provide energy and/or data to an electrical device located on an outside of the case, wherein the energy-data transfer unit is adapted to fit inside the first portion of the case; and, at least one electrical member embedded across a side of the first portion of the case, wherein the electrical member is adapted to be in electrical connection with the at least one energy-data transfer unit on the inside of the case and with the electrical device on the outside of the case.

In one aspect of the device, the electrical device is realized as a source of light and the case is waterproof.

In another aspect of the device, the light is selected from UV, visible, IR spectra or a combination thereof.

In another aspect of the device, the light is generated by at least one LED.

In another aspect of the device, the electronic device is realized as a camera and the electrical member is adapted to transfer data from the camera to the electric device.

In another aspect of the device, the electrical device is realized as a GPS navigational device, a screen, a graphical user interface, a touch screen, a wireless Ethernet-activated device, digital, cellular and analog video transmitter, a cellular phone, a USB-activated device or mobile computing device.

In another aspect of the device, the at least one energy-data transfer unit is adapted to receive primary/secondary lithium and/or alkaline batteries, AA or AAA batteries.

In another aspect of the device, the at least one energy-data transfer unit includes at least one lithium ion-based battery, AA battery or AAA battery.

In another aspect of the device, the at least one energy-data transfer unit includes batteries adapted to be recharged in situ.

In another aspect of the device, the camera is realized as a GoPro® camera and the case is realized as a GoPro® skeleton.

The invention includes a method for providing electrical energy and/or data to an electrical device placed on an outer side of a protective case, including the following: providing a protective case adapted to hold an electronic device in a first inner side; placing the electronic device within the case, wherein the electronic device is adapted to fit within the case on the first inner side and wherein the electronic device is present on a second external side of the case; placing a source of electrical energy in the case, wherein the source of electrical energy is adapted to fit within the inner side of the case and wherein the source is adapted to contact an electrical member traversing a side of the case; fitting an electrical device onto the second external side of the protective case and the electrical device is adapted to include an electrical connector adapted for electrical connection with the electrical member on the second external side of the case; closing the case; and, allowing electrical energy and/or data to flow from the source of electrical energy inside the case to the electrical device attached to the second external side of the case.

In one aspect of the method, the step of fitting is accomplished by reversibly attaching the electrical device to the second external side of the case via a plurality of attachment points.

In another aspect of the method, the electronic device is realized as a HD digital video camera and the electrical device is realized as a source of light.

In another aspect of the method, there is additionally a step of placing a data transfer element in the case, wherein the data transfer element is adapted to fit within the inner side of the case and wherein the data transfer element is adapted to transfer data from the inner side of the case to an electrical device on an outside of the case.

In another aspect of the method, there is an additional step of recharging the source of electrical energy.

The invention also includes a device for providing electrical energy to a camera light unit placed on the outside of a camera case, including: a camera; a case adapted to hold the camera, wherein the case is adapted to allow for control and use of the camera when the case is closed with the camera inside of the case; a source of electrical energy adapted to fit within the case when the camera is present in the case and the case is closed, wherein the electrical energy is adapted not to be supplied to the camera; a plurality of electrical leads adapted to contact the source of electrical energy on a first internal side of the case and be exposed on a second external side of the case; and, a camera light source adapted to be firmly attached to the case on the second external side and adapted to receive electrical energy from the source of electrical energy via the plurality of electrical leads.

In one aspect of the device, the light source includes a plurality of LED's with different wavelength profiles.

In another aspect of the device, there is additionally a switch to alternatively activate the white light or the infrared light.

In still another aspect of the device, there is additionally a cover adapted to cover and prevent projection of light from the light source.

In yet another aspect of the device, the light source is adapted to be turned on when the camera is turned on.

Unless otherwise defined here or in the embodiments, all technical and/or scientific terms used herein may have the same meaning as commonly understood by one of ordinary skill in the art to which the invention pertains. “Electronic device” may generally refer to a consumer electronics product including but not limited to digital cameras, smart phones, cellular phones, tablet computers, laptop computers, watches, mobile computing devices, tactical radios and wearable computing devices. An “electrical device” may generally refer to a peripheral or add-on for an electronic device; non-limiting examples of electrical devices may include a flashlight or GPS receiver or screen or touch screen or graphical user interface or infrared LED. A “case” or “protective case” in the instant invention may generally refer to a case that is separate from and independent of the electronic device placed within the case for the purpose of protection. A case may generally be made out of clear plastic or metal and in some cases may be water and/or shatter proof. Non-limiting examples of cases for the instant invention include products from Otter Box as well as skeletons sold by GoPro to completely cover and protect their cameras. Cases for the instant invention generally allow for access to some or all of the buttons or settings of a device within the case. A case may be composed of one or a plurality of separate pieces that may be reversibly joined to form a complete or holo-case.

“Electrical energy” and “data” may have their generally understood meanings in the art. An “energy-data transfer unit” may generally refer to an element of the instant invention that is typically placed within a protective case or a portion thereof. This element may be adapted to deliver electrical energy and/or data from within a closed protective case to an electrical device located outside of the protective case. In some embodiments, the energy-data transfer unit may be in electrical communication with the electronic device located inside the protective case. A lead, a plurality of leads, a USB socket or other element may be placed through one side of a case so as to allow electrical energy and/or data to be transferred from the energy-data transfer unit to an electrical device. The electrical device may be attached to an outer portion of the case or it may be completely free and outside of the case. An “electrical member” may generally be said lead, plurality of leads, a USB socket or the like that is in electrical connection with said energy-data transfer element and at least one electrical device or a wire connected to the at least one electrical device. LED and battery may have their generally understood meanings in the electrical arts. A battery for the instant invention may be any relevant type of battery or electrical energy accumulation device including but not limited to lithium ion batteries, alkaline batteries, AA, AAA batteries, rechargeable batteries, electrical capacitors and the like. LED's or any other light-emitting elements for the instant invention may be of any wavelength range including IR, visible and UV regions of the electromagnetic spectrum. “Source of electrical energy” may generally refer to batteries or a battery holder adapted to receive one or a plurality of batteries. A “cover” may generally refer to an element that may be placed reversibly over a flashlight or light source to cover the same. In some embodiments, a cover may activate turning on or turning off a light source associated with an electrical device.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100. Several black-and-white photographs have been incorporated into the Figures as they add to the understanding of the instant invention.

In the drawings:

FIG. 1 shows a picture of a prior art system for providing illumination to for a digital camera;

FIG. 2 shows a picture of an additional prior art invention in the field;

FIGS. 3A-3D show schematic views of a portion of a case as per an embodiment of the instant invention;

FIGS. 3E-3F show pictures of devices related to the embodiments of FIGS. 3A-3D;

FIG. 4 shows a picture associated with an embodiment of the instant invention;

FIG. 5 shows a schematic view of an embodiment of the instant invention;

FIG. 6 shows a schematic view of a feature of an embodiment of the instant invention;

FIGS. 7A & 7B show pictures of an LED flashlight according to an embodiment of the instant invention;

FIG. 8 shows a picture of an embodiment of the instant invention;

FIG. 9 shows a flowchart for a method associated with an embodiment of the instant invention;

FIG. 10 shows a flowchart for an alternative method associated with an embodiment of the instant invention;

FIG. 11 shows a flowchart for an alternative method associated with an embodiment of the instant invention;

FIGS. 12A-12B show schematic views of a flashlight associated with the instant invention;

FIG. 13 shows a picture of a device according to the instant invention as prepared for naval commandos;

FIG. 14 shows a picture of components of the device shown in FIG. 13; and,

FIG. 15 shows a schematic view of an embodiment in which an energy-data transfer element is not placed within a case associated with an electronic device.

### DESCRIPTION OF SPECIFIC EMBODIMENTS OF THE INVENTION

The present invention, in some embodiments thereof, relates to a means for providing electrical energy and/or data transfer from within a closed waterproof case holding an electronic device to an electrical add-on located on the outside of the same waterproof case.

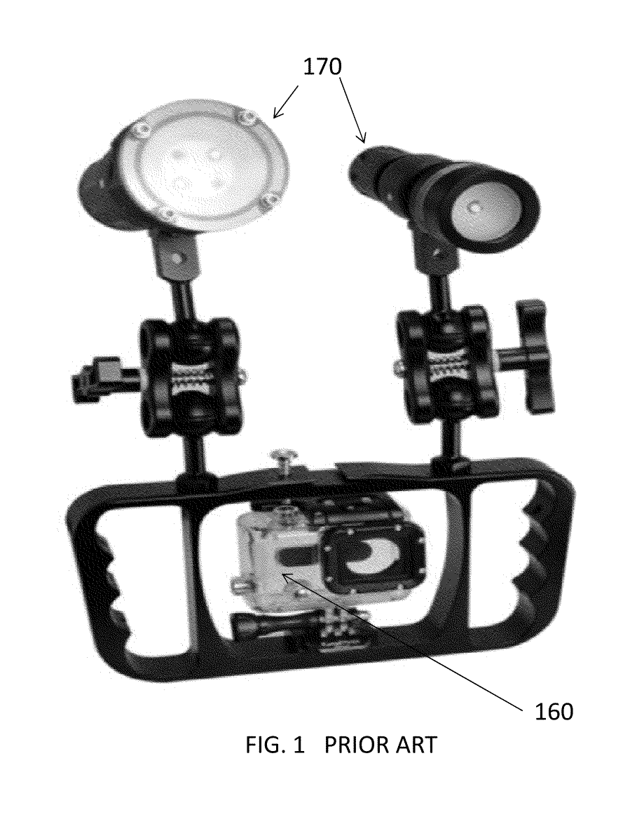

The instant invention addresses an important issue in a rapidly growing market. Miniaturized electronic devices such as digital video cameras and smart phones that include digital camera components are often limited in their battery life. While the possibility of adding more batteries externally to such devices does exist, the question is one of tradeoff. Specifically, the GoPro line of cameras and their associated “skeleton” cases are designed to be highly functional, rugged, and compact enough for easy use by athletes, soldiers and even film-makers. The challenge for these cameras comes when one wants additional functionality such as a flashlight to allow for nighttime use of the HD cameras. If one thinks about it, a GoPro camera is usable for half a day only. Adding a flashlight to a GoPro camera may be technically trivial or very involved, but the battery requirements for such an addition routinely destroy the compact nature of the invention. Attention is turned to FIG. 1 which shows a prior art concept for providing environmental lighting for use of a GoPro camera. As one can see from FIG. 1, the system of camera 160 and flashlights 170 is bulky and large—while it may provide enough light for successful nighttime filming, the system shown is not one that a soldier could put on his/her helmet or a surfer on the edge of his/her board.

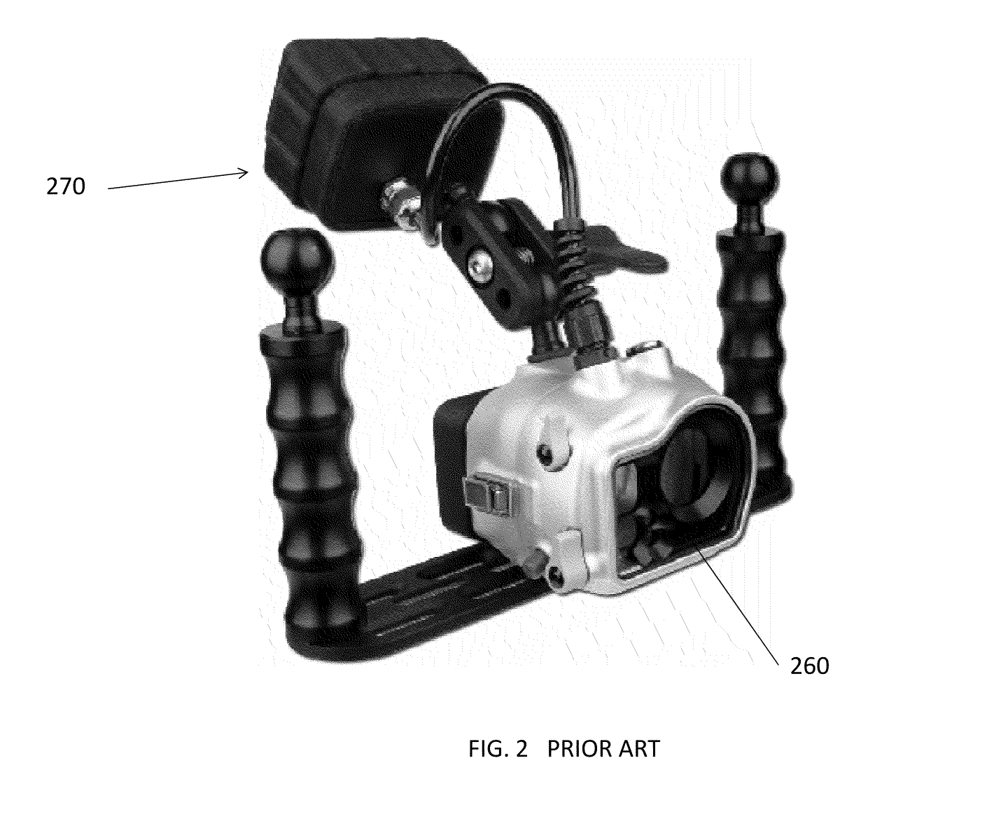

FIG. 2 shows an alternative prior art invention with a case for a GoPro camera 260 as well as a very large and bulky light source 270. While the prior art invention shown in FIG. 2 may function well, it is no longer a device that one may strap on a bike or the end of the ski.

The challenge is to keep the beauty and functionality of GoPro mini-cameras and their like while providing additional, desired functionalities. The instant invention, in some embodiments, places power sources within the space of a GoPro case and lets the energy be directed to small peripherals that are adapted to snuggly attach to the outside of a GoPro case so as to provide additional functionality without taking away the small profile of the camera.

For purposes of better understanding, some embodiments of the present invention are illustrated in the figures of the drawings. It is understood that any theory proffered in the following discussion is to aid in the better understanding of the invention only.

### First Embodiment

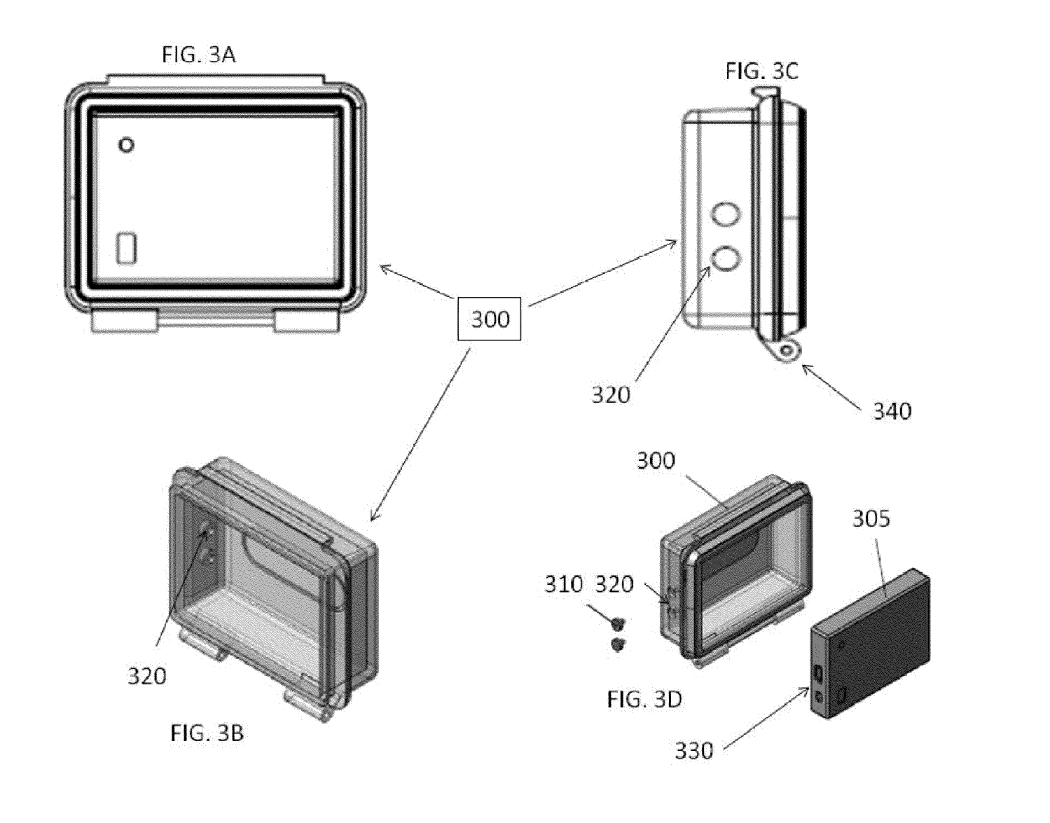

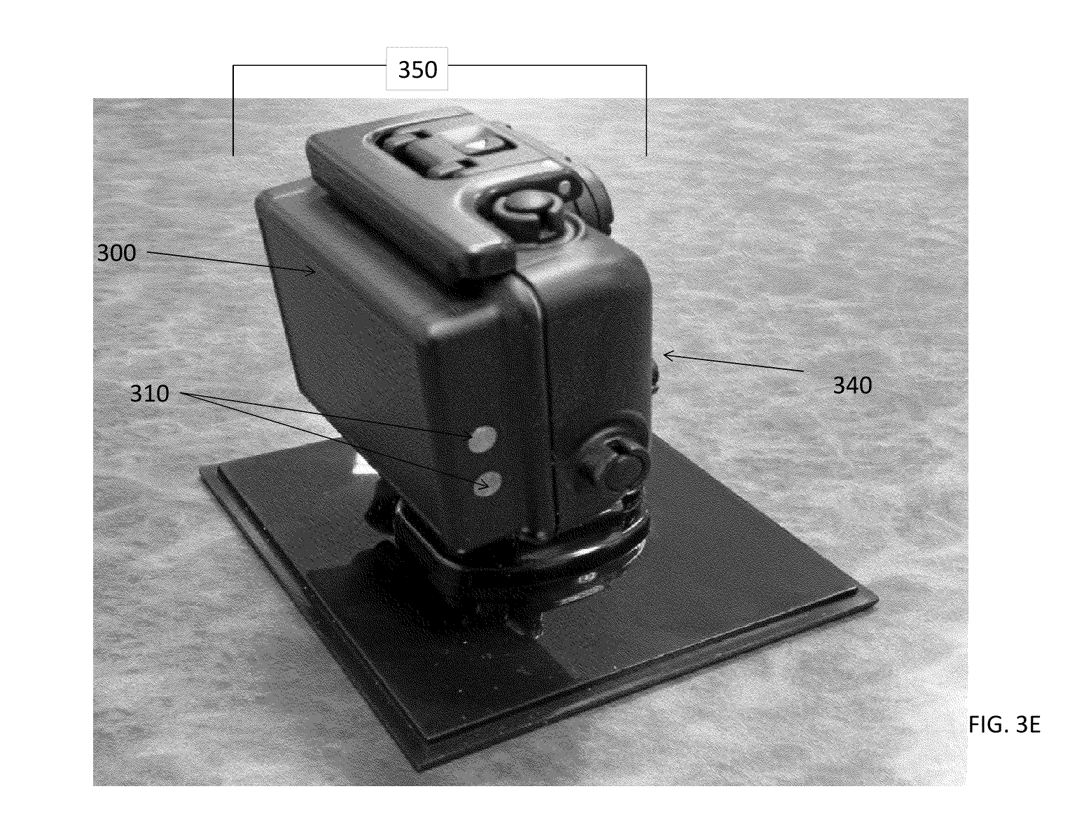

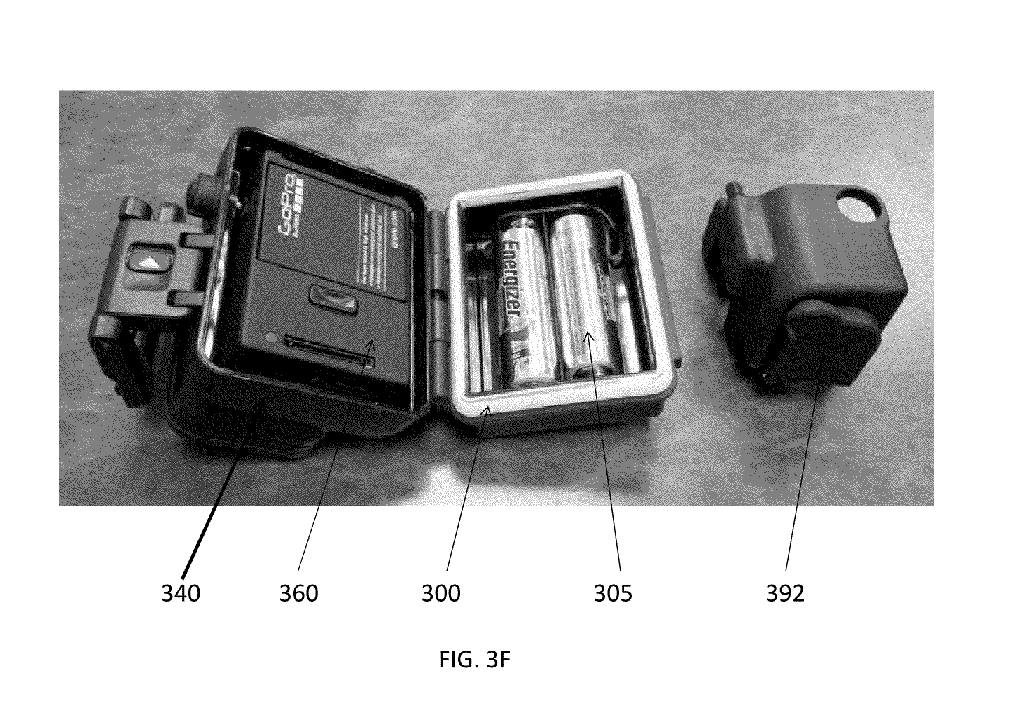

Attention is turned to FIG. 3A which shows a schematic view of a component of an embodiment of the instant invention. The invention includes a device for providing electrical energy or data from inside a protective case to an electrical device located outside of the protective case, including: a first portion of a case, the first portion adapted to reversibly attach to a second portion of the case to form a complete case for physical protection of an electronic device located inside and separate from the case; at least one energy-data transfer unit adapted to provide energy and/or data to an electrical device located on an outside of the case, wherein the energy-data transfer unit is adapted to fit inside the first portion of the case; and, at least one electrical member embedded across a side of the first portion of the case, wherein the electrical member is adapted to be in electrical connection with the at least one energy-data transfer unit on the inside of the case and with the electrical device on the outside of the case. FIGS. 3A-3D show a first portion 300 of a protective case (the case is not shown here in its entirety). The first portion 300 is adapted to attach to a second portion to form a waterproof case. The second portion is adapted to hold an electronic device such as a digital camera or a smartphone. An energy-data transfer unit (FIG. 3D) 305 is adapted to fit snuggly and securely within the first portion 300. The energy-data transfer unit 305 may provide electrical energy and/or data links for an electrical device placed outside of and optionally attached to the complete protective case (not shown). The energy-data transfer unit 305 may optionally be in electrical communication with the electronic device protected within the waterproof case.

The first portion 300 (FIGS. 3C & 3D) of the case is adapted with holes 320 (FIG. 3B) that allow for the placement of one or more electrical members 310 (FIG. 3D) that traverse from inside the first portion 300 to the outside of the first portion 300. The electrical members 310 are adapted to be either in physical and/or electrical contact with the energy-data transfer unit 305 placed within the first portion 300. Connection points 330 on the energy-data transfer unit 305 are adapted to contact the electrical members 310 embedded in the side of the first portion 300 of the case. It is understood that the electrical members 310 and their corresponding dedicated connection points on the energy-data transfer unit 305 may be placed in any relevant position with respect to the first portion 300 of the case. The first portion 300 also includes connectors 340 (FIG. 3C) for reversible attachment to a second portion to form a complete case for protection of the enveloped electronic device (not shown). The depth of the first portion 300 (FIG. 3B) is only that which is needed to hold the energy-data transfer unit 305 (FIG. 3D) and allow for closure of the case of which the first portion is a part. FIG. 3E shows an external view of the first portion 300 with conductive electrical members 310 that traverse a side of the first portion 300 as well as a second portion 340 which together with the first portion 300 make for a holo-case 350 around an enclosed electronic device (not visible).

FIG. 3F shows major components of the instant embodiment in a working prototype of the invention: electronic device 361, first portion 300 of case, second portion 340 of case, energy-data transfer element 305 and electrical device 392 adapted to be attached to an outer position around the second portion 340 of the case.

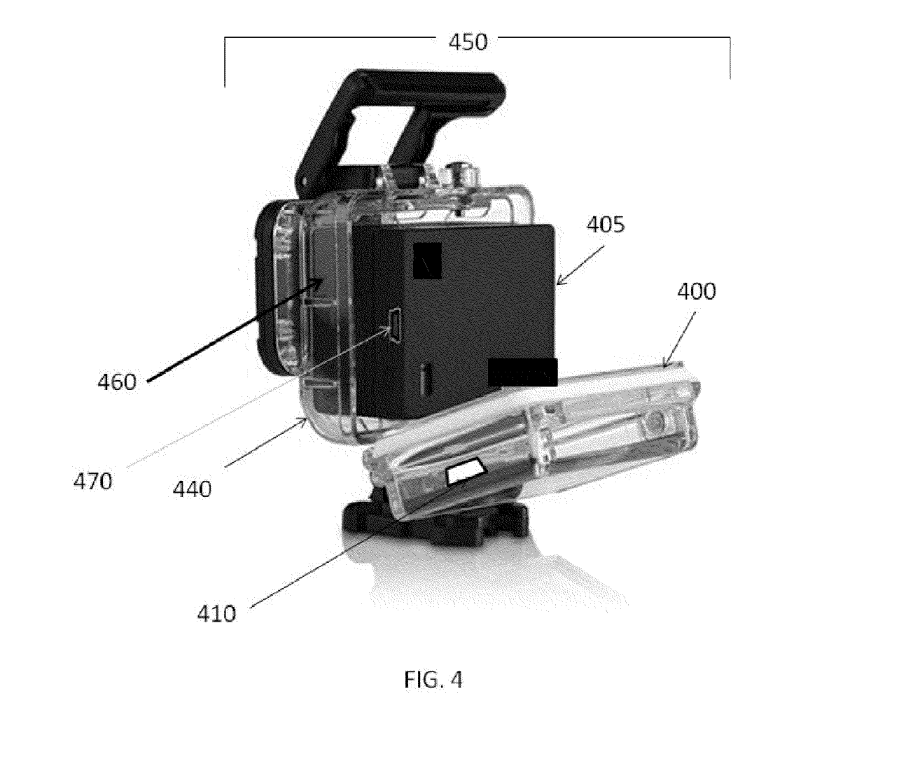

Attention is turned to FIG. 4. A first portion 400 of a complete case 450 is shown attached to a second portion 440 of said case 450. An electronic device 460 realized as a GoPro digital camera is adapted to fit snuggly within said second portion 440. An energy-data transfer unit 405 is shown and is adapted to fit snuggly within the first portion 400 of the case, which is shown open for ease of viewing. A data USB port 470 on the energy-data transfer unit 405 is adapted to transfer data from the camera 460 to an electrical device outside of the case 450 (not shown). Electrical member 410 is realized as a USB adapter that is adapted to receive data from camera 460 via USB port 470 and transfer said data to an electrical device placed outside of the case 450. In this embodiment, the energy-data transfer unit 405 is in electrical communication with the camera 460 so as to receive video and other data from the camera 460. The energy-data transfer element 405 may then transfer said data via the electrical member 410 to an electrical device or a plurality of electrical devices placed outside of the sealed, waterproof case 450. Typical electrical devices (not shown) for this embodiment may include a WiFi router, a data storage device or GPS receiver or a display screen.

### Second Embodiment

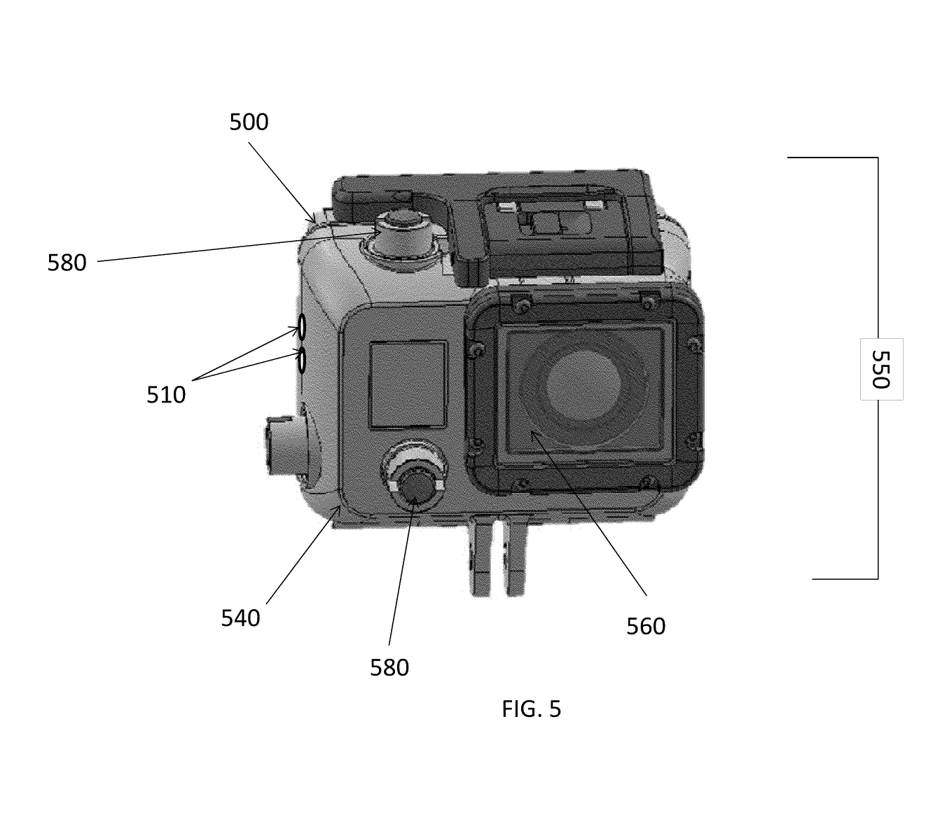

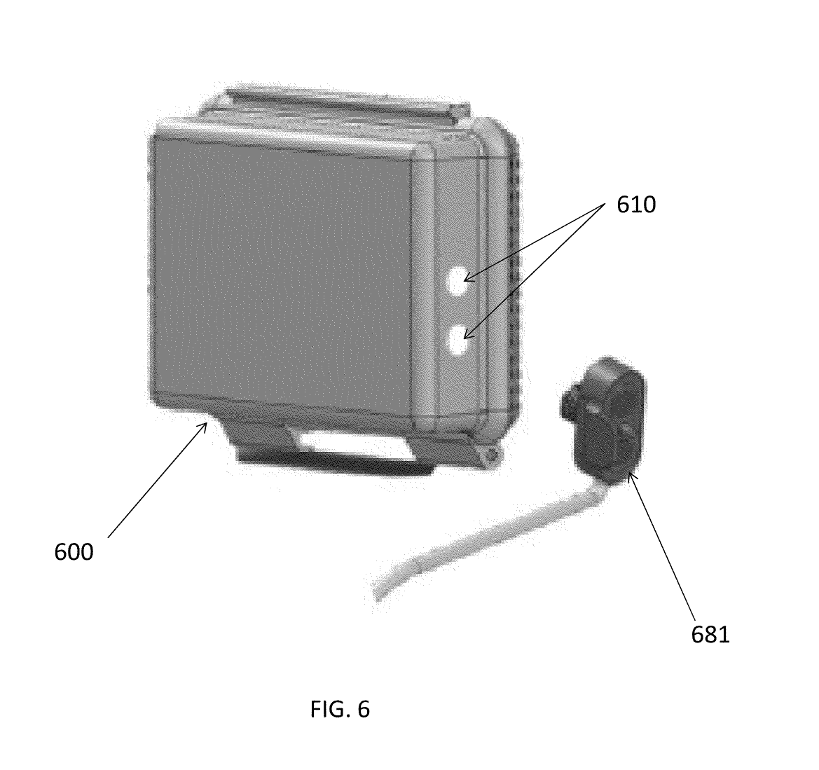

Attention is turned to FIG. 5 which shows a schematic view of a protective case 550 surrounding a camera 560. The second portion 540 of the case 550 includes protective buttons 580 that allow for facile activation and control of the camera 560 while the latter is in the case 550. Electrical members 510 are visible from the first portion 500 of the case 550 and allow for the transfer of electrical energy from the energy-data transfer unit (not visible from this view) to an electrical device that is external to the case 550. In this embodiment, the energy-data transfer unit may include batteries or other sources of electrical power. If batteries are utilized, they may be any relevant form of batteries including but not limited to lithium ion batteries, alkaline batteries, batteries of any appropriate size including AA and AAA batteries, a plurality of batteries, and rechargeable batteries. In some embodiments, the energy-data transfer element may itself receive electrical energy from an external source. In FIG. 6, an external energy source 681 is adapted to contact electrical members 610 to allow for electrical energy transfer to the energy-data transfer unit (not visible) held in the first portion 600 of a case for an electronic device. The energy source 681 may alternatively or additionally be used to recharge batteries associated with the energy-data transfer unit fitted into the first portion 600 of a case. The energy source 681 may additionally or alternatively be adapted to receive or transfer data to the energy-data transfer unit. The energy source 681 may in some embodiments be used to recharge batteries of an electronic device in the case or provide energy directly to an associated electronic device.

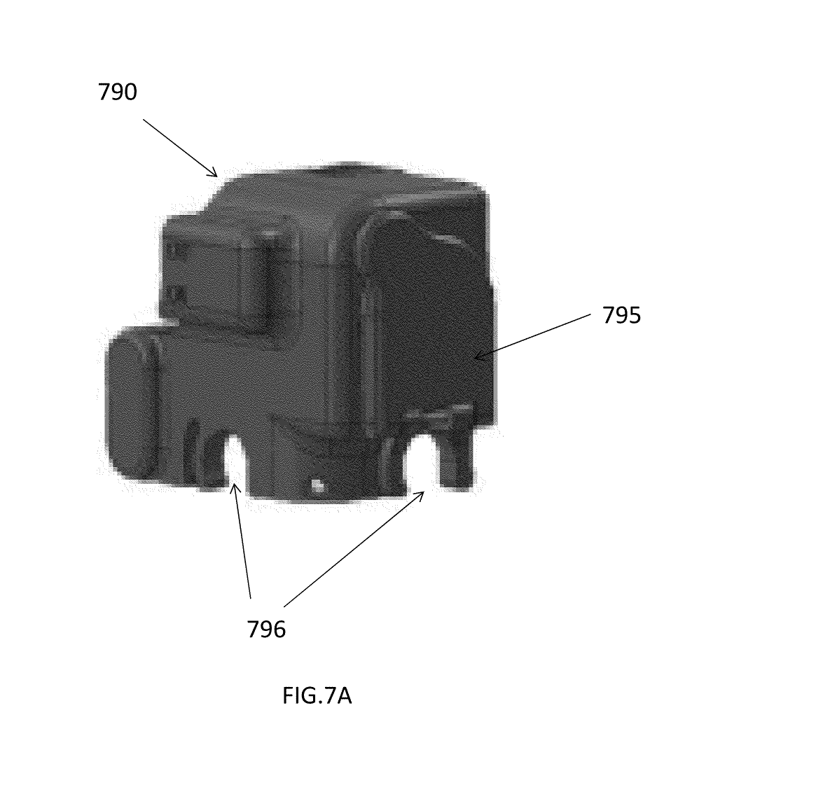

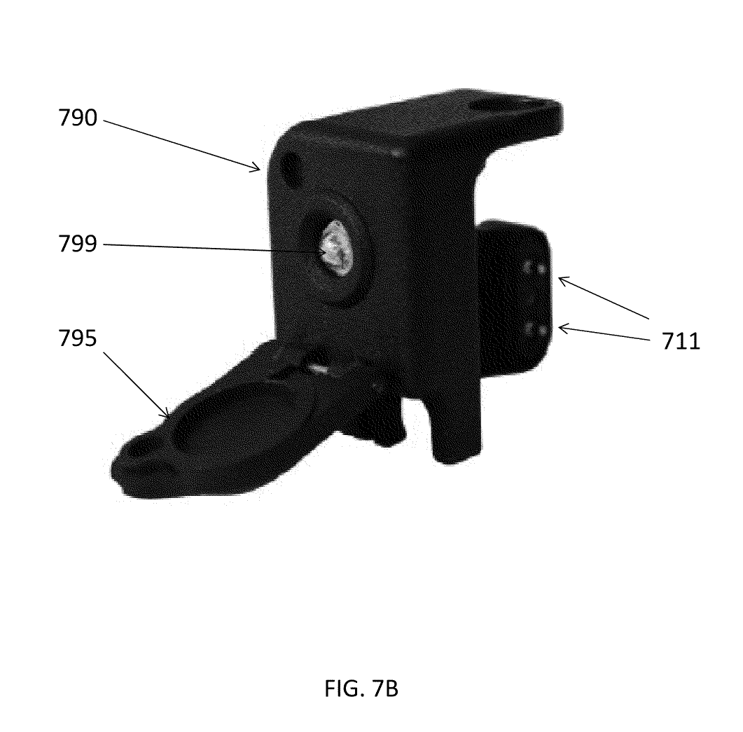

Attention is turned to FIG. 7A. FIG. 7A shows an LED flashlight 790 adapted to be fitted onto an outer portion of a case holding an electronic device such as a digital video camera. The LED flashlight 790 shown is adapted to fit tightly on a GoPro waterproof skeleton (not shown). The LED flashlight 790 includes a cover 795 that may be reversibly opened and closed to allow light to be shown on the environment immediately in front of a camera lens protected in the skeleton. Alternatively and additionally, the cover 795 may include a mechanism for turning on (when open) and turning off (when closed) one or a plurality of LED's present in the flashlight 790. Non-LED lighting is also possible. Arch-shaped connector elements 796 are included with the LED flashlight 790 to allow for facile and strong reversible attachment of the flashlight to a GoPro skeleton. It is understood that the shape of the flashlight 790 may be modified to allow for facile attachment to any relevant protective case for any electronic device. Such cases are generally waterproof and shatterproof. The instant flashlight 790 was specifically developed for the GoPro line of products as the flashlight receives its energy from an energy-data transfer unit inside of a GoPro case (as supplied by manufacturer or produced independently); the small size of the flashlight 790 (around 36 grams total mass) means that the GoPro case may still be used for action night video, as the overall size and weight of the camera and its case have not changed significantly. FIG. 7B shows the LED flashlight 790 with the cover 795 in an open position to reveal a LED 799 that provides the light of the flashlight 790. The cover 795 is adapted to be opened and closed either automatically or by a user. One may also see the electrical connectors 711 which are adapted to receive electrical energy from an associated energy-data transfer unit (not shown) via electrical members placed through a portion of an associated case.

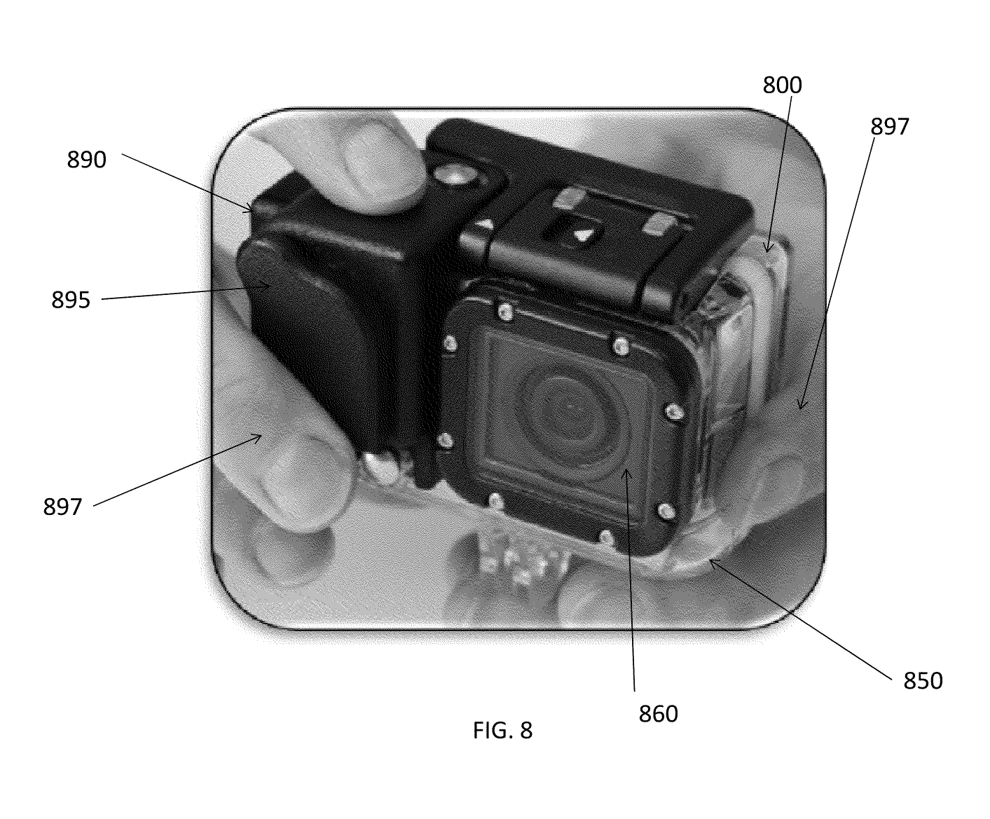

Attention is turned to FIG. 8. FIG. 8 shows a camera 860 with case 850 and a fully attached electrical device flashlight 890. A user's fingers 897 give an idea of the compact size of the holo-unit that includes camera 860, case 850 and LED flashlight 890. Note that the flashlight 890 cover 895 is shown closed and covered by a finger 897 in FIG. 8. A magnet (not visible) may be employed in holding cover 895 shut. The energy-data transfer unit (not visible) inside the first portion 800 of the case 850 provides all of the electricity for the flashlight 890. By placing the energy source for the flashlight 890 inside of the existing case 850, the instant embodiment allows for a compact flashlight 890 that blends well with the commercial case 850. It is noted that the case 850 is a commercially-available GoPro case that has been modified to allow for electrical members (not visible due to flashlight 890) and installation of an energy-data transfer element that includes a lithium ion battery. The LED flashlight 890 is expected to provide several hours of white or infrared light for the battery employed in the energy-data transfer element.

### Third Embodiment

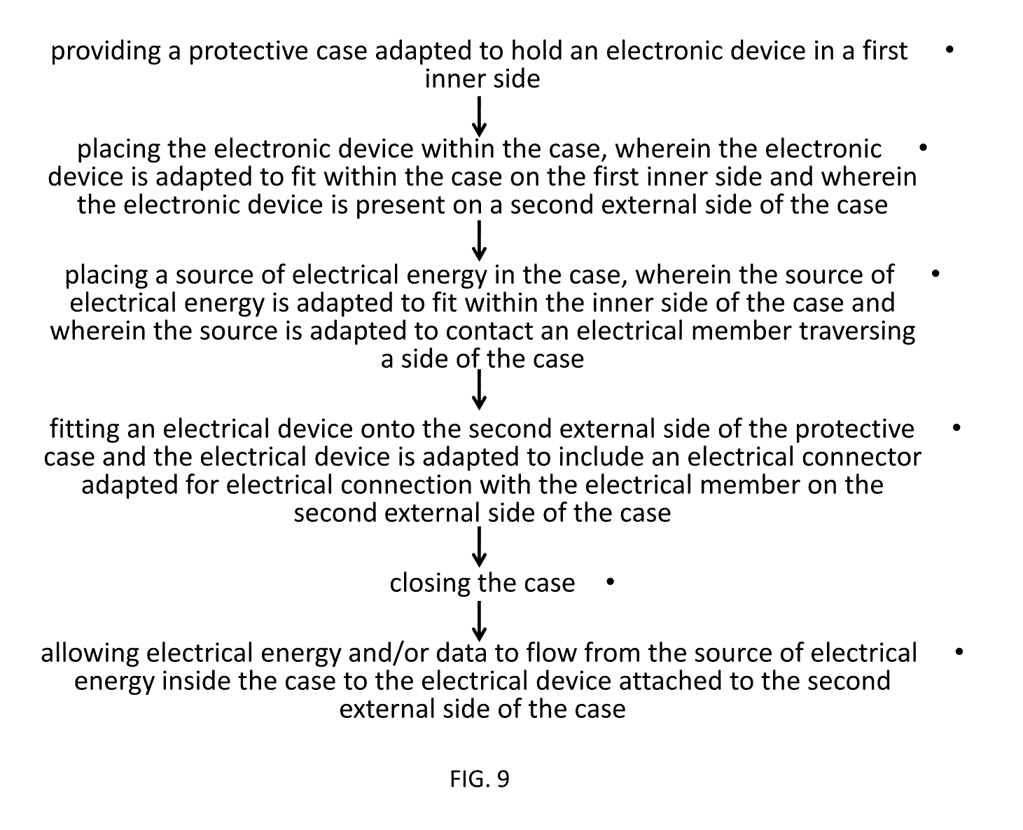

Attention is turned to FIG. 9 which shows a flowchart representing a method for the instant invention. The invention includes a method for providing electrical energy to an electrical device placed on an outer side of a protective case, including the following: providing a protective case adapted to hold an electronic device in a first inner side; placing the electronic device within the case, wherein the electronic device is adapted to fit within the case on the first inner side and wherein the electronic device is present on a second external side of the case; placing a source of electrical energy in the case, wherein the source of electrical energy is adapted to fit within the inner side of the case and wherein the source is adapted to contact an electrical member traversing a side of the case; fitting an electrical device onto the second external side of the protective case and the electrical device is adapted to include an electrical connector adapted for electrical connection with the electrical member on the second external side of the case; closing the case; and, allowing electrical energy and/or data to flow from the source of electrical energy inside the case to the electrical device attached to the second external side of the case. The protective case may generally be made of hardened, clear plastic. The case may optionally be waterproof as well as shatterproof. GoPro skeleton cases are non-limiting examples of a case that holds an electronic device (a GoPro camera) and is made of two parts, though a case may be made of a single openable/closable case. The source of electrical energy may generally be realized as one or a plurality of batteries. A battery holder may be provided and a user may supply his/her own AA, AAA or other relevant batteries for use as a source of electrical energy. The source of electrical energy fits within the case so as to allow a portion of said source to contact electrical members that traverse a portion of the case so as to allow the electrical energy stored in or associated with the source of electrical energy to be directed outwards towards an associated electrical device. An electrical device may be attached permanently or reversibly to the case, which is separate from and independent of the electronic device; alternatively, the electrical device may simply sit outside of the case without any direct attachment/association with the case. The source of electrical energy may be rechargeable or parts of it may be disposable.

### Fourth Embodiment

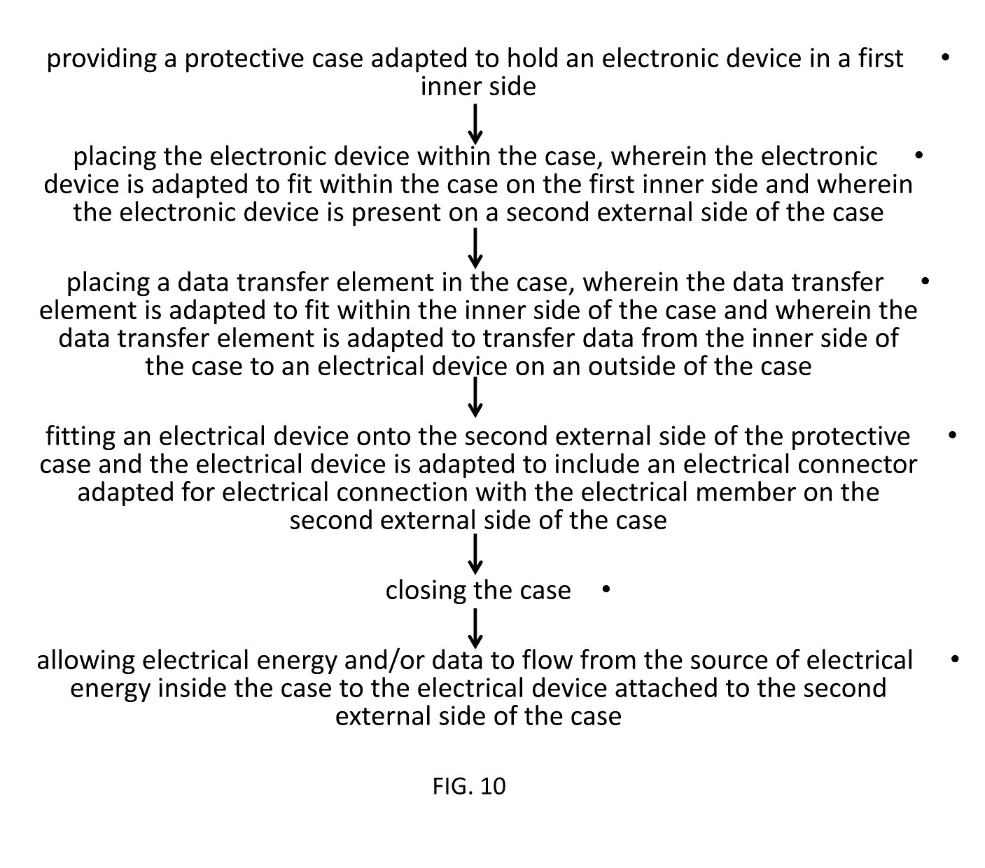

Attention is turned to FIG. 10 which shows a flowchart representing a method for the instant invention. The invention includes a method for providing data to an electrical device placed on an outer side of a protective case, including the following: providing a protective case adapted to hold an electronic device in a first inner side; placing the electronic device within the case, wherein the electronic device is adapted to fit within the case on the first inner side and wherein the electronic device is present on a second external side of the case; placing a data transfer element in the case, wherein the data transfer element is adapted to fit within the inner side of the case and wherein the data transfer element is adapted to transfer data from the inner side of the case to an electrical device on an outside of the case; fitting an electrical device onto the second external side of the protective case and the electrical device is adapted to include an electrical connector adapted for electrical connection with the electrical member on the second external side of the case; closing the case; and, allowing electrical energy and/or data to flow from the source of electrical energy inside the case to the electrical device attached to the second external side of the case. The protective case may generally be made of hardened, clear plastic. The case may optionally be waterproof as well as shatterproof. GoPro skeleton cases are non-limiting examples of a case that holds an electronic device (GoPro camera) and is made of two parts, though a case may be made of a single openable/closable case. The data transfer element may generally be realized as a USB connector or other appropriate element adapted to transfer digital data such as video data. The data transfer element is adapted to fit in an inner portion of a case as described in the previous embodiments. The data transfer element may include an energy source to facilitate data transfer which may be in one or two directions. The data transfer element is generally in electrical communication with the electronic device placed inside the case. An electrical device may be attached permanently or reversibly to an outer portion of the case, which is separate from and independent of the electronic device or the electrical device may simply sit outside of the case without any direct attachment/association with the case. The source of electrical energy may be rechargeable or parts of it may be disposable.

### Fifth Embodiment

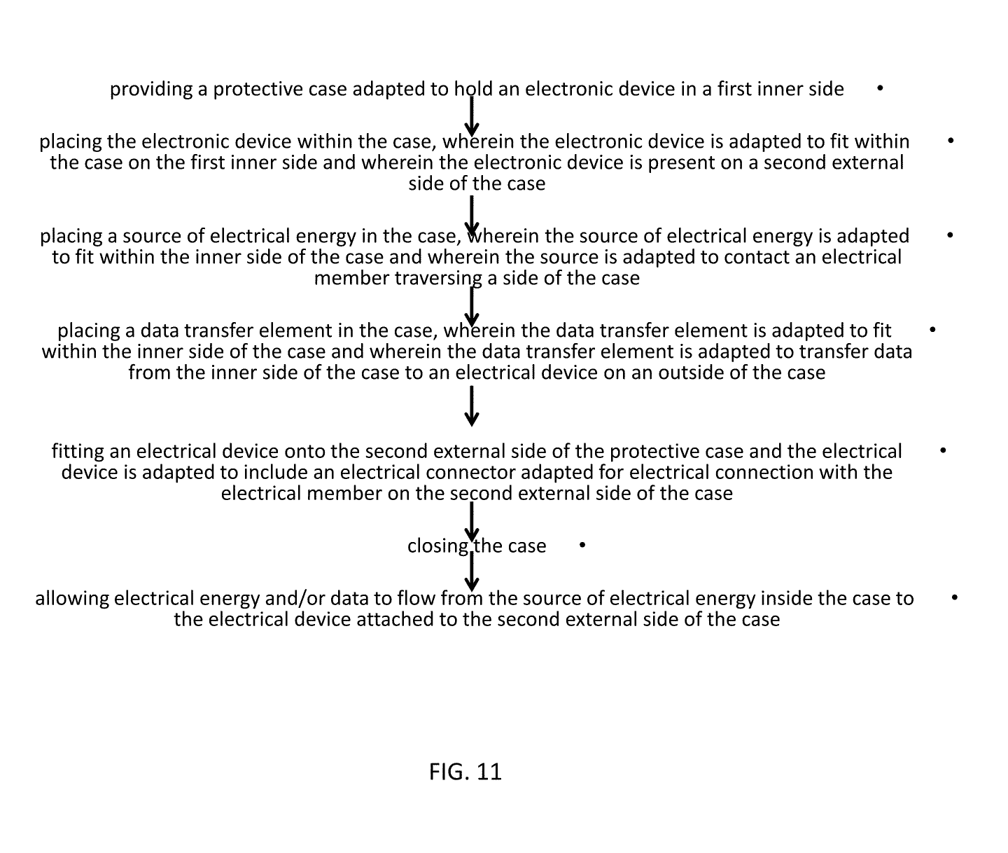

Attention is turned to FIG. 11 which shows a flowchart representing a method for the instant invention. The invention includes a method for providing electrical energy and/or data to an electrical device placed on an outer side of a protective case, including the following: providing a protective case adapted to hold an electronic device in a first inner side; placing the electronic device within the case, wherein the electronic device is adapted to fit within the case on the first inner side and wherein the electronic device is present on a second external side of the case; placing a source of electrical energy in the case, wherein the source of electrical energy is adapted to fit within the inner side of the case and wherein the source is adapted to contact an electrical member traversing a side of the case; placing a data transfer element in the case, wherein the data transfer element is adapted to fit within the inner side of the case and wherein the data transfer element is adapted to transfer data from the inner side of the case to an electrical device on an outside of the case; fitting an electrical device onto the second external side of the protective case and the electrical device is adapted to include an electrical connector adapted for electrical connection with the electrical member on the second external side of the case; closing the case; and, allowing electrical energy and/or data to flow from the source of electrical energy inside the case to the electrical device attached to the second external side of the case. The protective case may generally be made of hardened, clear plastic. The case may optionally be waterproof as well as shatterproof. GoPro skeleton cases are non-limiting examples of a case that holds an electronic device (GoPro camera) and is made of two parts, though a case may be made of a single openable/closable case. The source of electrical energy may generally be realized as one or a plurality of batteries. A battery holder may be provided and a user may supply his/her own AA, AAA or other relevant batteries for use as a source of electrical energy. The source of electrical energy fits within the case so as to allow a portion of said source to contact electrical members that traverse a portion of the case so as to allow the electrical energy stored in or associated with the source of electrical energy to be directed outwards to an associated electrical device. The data transfer element may generally be realized as a USB connector or other appropriate element adapted to transfer digital data such as video data. The data transfer element is adapted to fit in an inner portion of a case as described in the previous embodiments. The data transfer element may include an energy source to facilitate data transfer which may be in one or two directions. The data transfer element is generally in electrical communication with the electronic device placed inside the case. An electrical device may be attached permanently or reversibly to the case, which is separate from and independent of the electronic device or the electrical device may simply sit outside of the case without any direct attachment/association with the case. The source of electrical energy may be rechargeable or parts of it may be disposable.

### Example 1

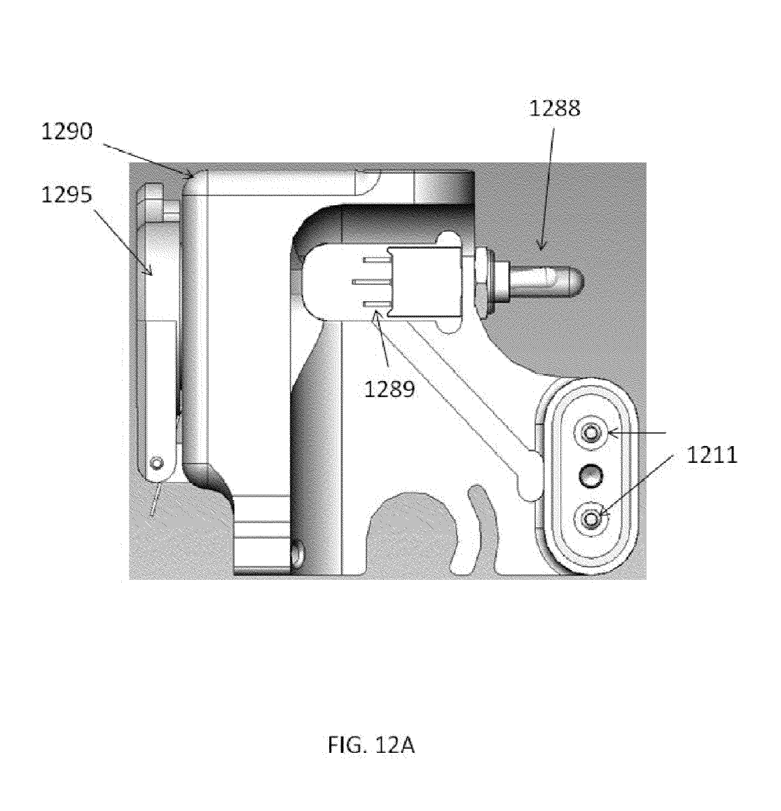

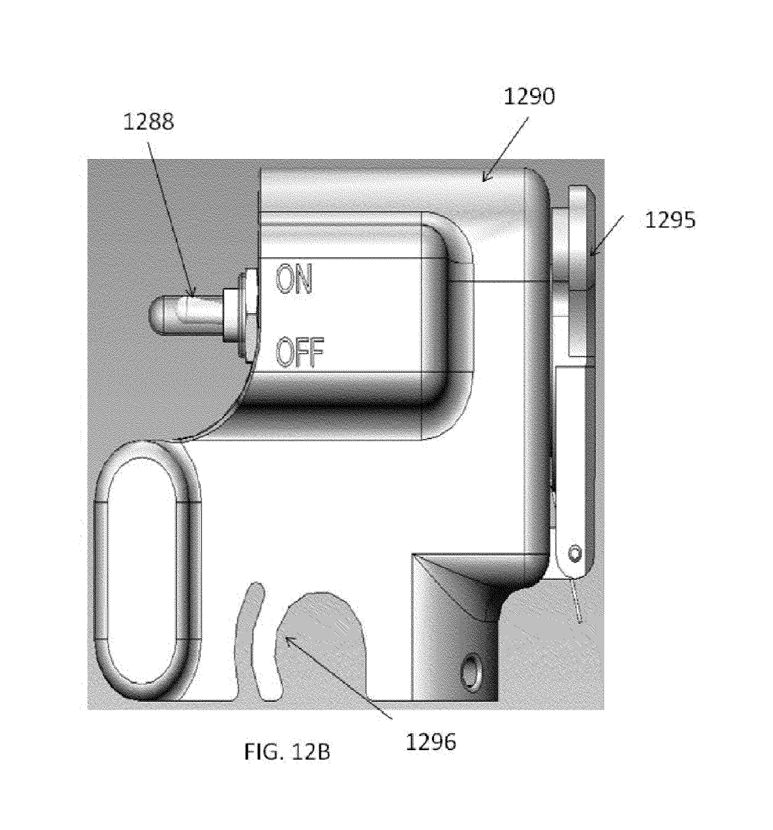

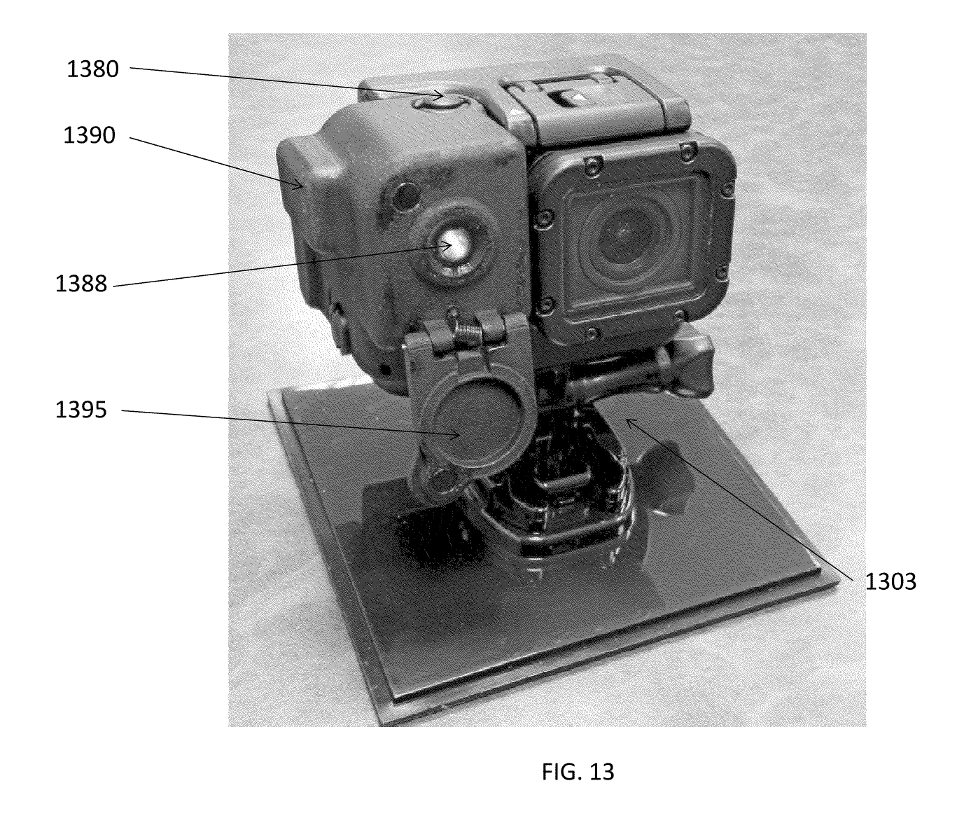

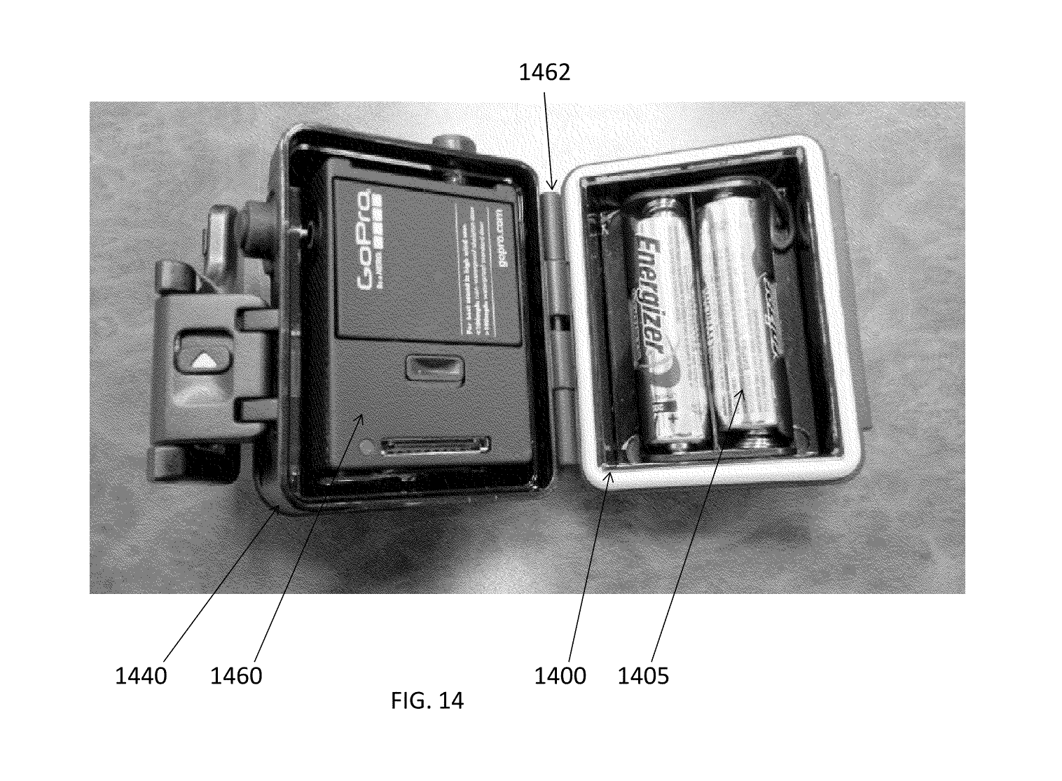

A GoPro Hero3+ was procured. A GoPro skeleton appropriate for use with this camera as well as a GoPro BacPac Lithium ion energy (4 Wh total) source were procured. The back panel of the skeleton was modified to allow two electrodes to be placed across a portion of the back panel. Additionally, the BacPac was modified to allow electrical energy from the rechargeable lithium ion batteries to be directed towards a flashlight secured on the outside of the skeleton. The front of the GoPro case was not at all modified. A flashlight 1290 (FIG. 12A) was produced from hard black plastic. Features of the flashlight 1290 include connector elements 1296 (FIG. 12B) adapted to fit to the front of the GoPro Hero3+ skeleton as provided by manufacturer. An on/off switch 1288 is also shown as are connectors 1289 for the LED (not shown). The LED used in this example was rated 1-5 Watts and had a wavelength range of 300 nm to 980 nm, thus covering the entire visible spectrum. Electrical connectors 1211 pogo pins adapted to receive electricity from the two electrodes placed through the case are shown. The penultimate source of the electrical energy is an energy-data transfer element fully enclosed in the case (not shown). FIG. 12B further details the on/off switch 1288, connector element 1296 and cover 1295 associated with flashlight 1290. A magnet (not shown) may be used to secure cover 1295 shut and/or initiate LED operation or cessation of LED operation. The total mass of the flashlight 1290 and energy data transfer element (realized as batteries) was 100 grams. The flashlight 1290 was successfully integrated onto the outer surface of the unmodified front of the GoPro skeleton, while the BacPac was modified to provide electrical energy from within the skeleton to the flashlight 1290 on the outside of the skeleton. The LED was controllable by the on/off switch 1288 and the overall profile of the camera and case was barely modified. FIG. 13 shows a working device prepared for commandoes with cover 1395 open to reveal LED 1388, with the overall camera/case 1303 profile nearly unchanged. It is noted how flashlight 1390 sits flush over shutter button 1380. FIG. 14 shows the various components of the working example: camera 1460, protective case opened at hinge 1462, energy-data transfer unit 1405 realized as a plurality of non-rechargeable alkaline batteries, first portion 1400, and second portion 1440 of case 1450.

Invention specifications for the energy-data transfer unit 1405 are described below:
The energy-data transfer unit is composed of two energy supply options:
Wireless power interface where AA/AAA/9 v batteries are assembled within a waterproof casing and provide an external energy interface to the externally assembled flashlight. In this configuration, the original volume of the basic camera is increased by the modular GoPro BACPAC waterproof case
Wired power interface with an optional AA/AAA/9 v batteries or an open lead configuration. In this configuration a connector is used as interface to the flashlight power feed. In this configuration the basic volume of the camera is maintained and a remote power pack is fitted in a location of user discretion
The energy pack's weight is under 80 grams

### Sixth Embodiment

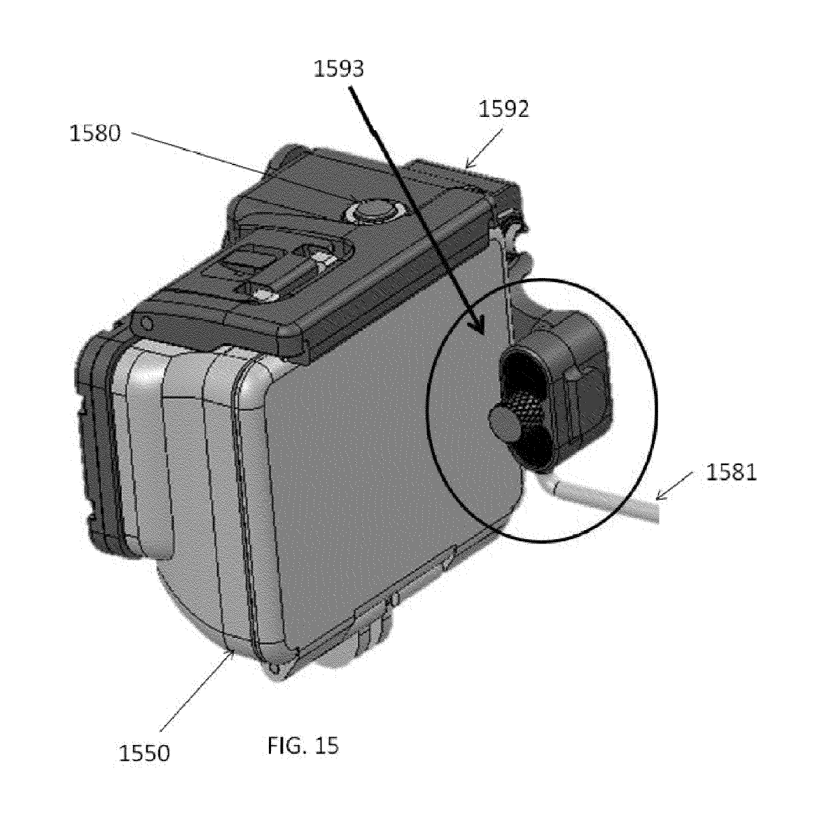

Attention is turned to FIG. 15. The instant invention may also work with the energy-data transfer unit 1505 physically outside of the case 1550 and even physically removed from the case 1550. In some embodiments, a wire 1581 may be used to attach an electrical device 1592 placed on the outside of a protective case 1550 to a source of energy or a recipient of data from an electronic device placed within said case (not visible). In this embodiment, the energy-data transfer element is not placed within the case 1550; it may be placed in proximity to and outside of the case or it may be, with the aid or an appropriate wire 1581 or other connector, be placed at some predetermined distance from the case 1550 holding an electronic device. Electrical device 1592 is adapted to include a receptor 1593 which may receive electricity, for example, from the wire 1581 associated with an energy-data transfer element placed away from the case 1550 (for example: camera and electrical device 1592 on head of soldier in front, with battery pack at rear of soldier's head, a wire 1581 connecting the camera to the battery pack). It is noted that the electrical device 1592 is joined around buttons 1580 that project outwards from the case 1550 and serve to hold the electrical device 1592 firmly in place on the case 1550.

Embodiments of the instant invention may be included in other products where energy and/or data are transferred from within a space to an electrical device or the like outside of that space, wherein said space is defined by some type of closed container.

Some embodiments of the instant invention may also include other features or components to make the invention more functional or robust. An electronic device may be realized as a plurality of electronic devices. An electrical device may be realized as a plurality of electrical devices. An energy-data transfer element may be realized as a plurality of similar or dissimilar energy-data transfer elements.

It is expected that during the life of a patent maturing from this application, additional systems for providing energy from within a case to an electrical add-on outside of a case may be developed, and the scope of the term of the invention is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there_between.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for a wide variety of embodiments with differentially sized cases as herewith described. The instant invention may be employed for fixed location cases or other arrangements not directly described herewith.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Certain embodiments of the instant invention may include design features that allow for easy attachment and removal of an electrical device to and from a case.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A device for providing electrical energy or data from inside a protective case to an electrical device located outside of said protective case, including:
a first portion of a case, said first portion adapted to reversibly attach to a second portion of said case to form a complete case for physical protection of an electronic device located inside and separate from said case;
at least one energy-data transfer unit adapted to provide energy and/or data to an electrical device located on an outside of said case, wherein said energy-data transfer unit is adapted to fit inside said first portion of said case; and,
at least one electrical member embedded across a side of said first portion of said case, wherein said electrical member is adapted to be in electrical connection with said at least one energy-data transfer unit on said inside of said case and with said electrical device on said outside of said case.

2. The device according to claim 1, wherein said electrical device is realized as a source of light and said case is waterproof.

3. The device according to claim 2, wherein said light is selected from UV, visible, IR spectra or a combination thereof.

4. The device according to claim 3, wherein said light is generated by at least one LED.

5. The device according to claim 1, wherein said electronic device is realized as a camera and said electrical member is adapted to transfer data from said camera to said electric device.

6. The device according to claim 1, wherein said electrical device is realized as a GPS navigational device, a screen, a graphical user interface, a touch screen, a wireless Ethernet-activated device, digital, cellular and analog video transmitter, a cellular phone, a USB-activated device or mobile computing device.

7. The device according to claim 1, wherein said at least one energy-data transfer unit is adapted to receive primary/secondary lithium and/or alkaline batteries, AA or AAA batteries.

8. The device according to claim 7, wherein said at least one energy-data transfer unit includes at least one lithium ion-based battery, AA battery or AAA battery.

9. The device according to claim 8, wherein said at least one energy-data transfer unit includes batteries adapted to be recharged in situ.

10. The device according to claim 5, wherein said camera is realized as a GoPro® camera and said case is realized as a GoPro® skeleton.

11. A method for providing electrical energy and/or data to an electrical device placed on an outer side of a protective case, including the following:
providing a protective case adapted to hold an electronic device in a first inner side;
placing said electronic device within said case, wherein said electronic device is adapted to fit within said case on said first inner side and wherein said electronic device is present on a second external side of said case;
placing a source of electrical energy in said case, wherein said source of electrical energy is adapted to fit within said inner side of said case and wherein said source is adapted to contact an electrical member traversing a side of said case;
fitting an electrical device onto said second external side of said protective case and said electrical device is adapted to include an electrical connector adapted for electrical connection with said electrical member on said second external side of said case;
closing said case; and,
allowing electrical energy and/or data to flow from said source of electrical energy inside said case to said electrical device attached to said second external side of said case.

12. The method according to claim 11, wherein said step of fitting is accomplished by reversibly attaching said electrical device to said second external side of said case via a plurality of attachment points.

13. The method according to claim 11, wherein said electronic device is realized as a HD digital video camera and said electrical device is realized as a source of light.

14. The method according to claim 11, further including a step of placing a data transfer element in said case, wherein said data transfer element is adapted to fit within said inner side of said case and wherein said data transfer element is adapted to transfer data from said inner side of said case to an electrical device on an outside of said case.

15. The method according to claim 11, further including a step of recharging said source of electrical energy.

16. A device for providing electrical energy to a camera light unit placed on the outside of a camera case, including:
a camera;
a case adapted to hold said camera, wherein said case is adapted to allow for control and use of said camera when said case is closed with said camera inside of said case;
a source of electrical energy adapted to fit within said case when said camera is present in said case and said case is closed, wherein said electrical energy is adapted not to be supplied to said camera;
a plurality of electrical leads adapted to contact said source of electrical energy on a first internal side of said case and be exposed on a second external side of said case; and,
a camera light source adapted to be firmly attached to said case on said second external side and adapted to receive electrical energy from said source of electrical energy via said plurality of electrical leads.

17. The device according to claim 16, wherein said light source includes a plurality of LED's with different wavelength profiles.

18. The device according to claim 17, further including a switch to alternatively activate said white light or said infrared light.

19. The device according to claim 16, further including a cover adapted to cover and prevent projection of light from said light source.

20. The device according to claim 16, wherein said light source is adapted to be turned on when said camera is turned on.
